(19) United States
(12) Patent Application Publication
(10) Pub. No.: US 2025/0079068 A1
(43) Pub. Date: Mar. 6, 2025

(54) COIL ELECTRONIC COMPONENT

(71) Applicant: SAMSUNG ELECTRO-MECHANICS CO., LTD., Suwon-si (KR)

(72) Inventors: Jun Tae Kang, Suwon-si (KR); Woonghwan Choi, Suwon-si (KR); Iljin Park, Suwon-si (KR); Taeryung Hu, Suwon-si (KR); Sle Lee, Suwon-si (KR); Heeju Kim, Suwon-si (KR); Seonwoo Oh, Suwon-si (KR); Donghyeon Kim, Suwon-si (KR); Byeongseon Kuk, Suwon-si (KR)

(73) Assignee: SAMSUNG ELECTRO-MECHANICS CO., LTD., Suwon-si (KR)

(21) Appl. No.: 18/809,843

(22) Filed: Aug. 20, 2024

(30) Foreign Application Priority Data
Sep. 4, 2023 (KR) 10-2023-0117029

(51) Int. Cl. H01F 27/28; H01F 27/29; H01F 27/32

(52) U.S. Cl. CPC H01F 27/2804; H01F 27/292; H01F 27/323; H01F 2027/2809

(57) ABSTRACT

A coil electronic component includes a main body; a coil embedded in the main body, an insulating layer disposed on one surface of the main body, a first conductive layer covering a portion of the one surface, a second conductive layer covering another portion of the one surface, and first and external electrodes respectively covering the first conductive layer. The coil electronic component has a first length L1 in a first direction, and a second length L2 is a sum of a third length L3 in the first direction of a region where the insulating layer, the first conductive layer, and the first external electrode overlap and a fourth length L4 in the first direction of a region where the insulating layer, the second conductive layer, and the second external electrode overlap. A ratio L2/L1 is 0.3 or more and 0.7 or less.

### CROSS-REFERENCE TO RELATED APPLICATION

This application claims priority to and the benefit of Korean Patent Application No. 10-2023-0117029 filed in the Korean Intellectual Property Office on Sep. 4, 2023, the entire contents of which are incorporated herein by reference.

### TECHNICAL FIELD

The present disclosure relates to a coil electronic component.

### BACKGROUND

In recent years, as the functionality of mobile devices has diversified, power consumption has increased. For this reason, coil electronic components with low loss and high efficiency have been adopted around power management integrated circuits (PMICs) in order to increase the usage times of the batteries in the mobile devices.

There is a growing need for thin inductors (power inductors) to slim down products and increase the degree of freedom in component placement. However, in this case, an increase in current leakage and a decrease in breakdown voltage (BDV) may occur. If the surfaces of external electrodes are not flat or a sufficient molded underfill (MUF) gap cannot be secured, it may be difficult to achieve mounting stability.

### SUMMARY

The present disclosure attempts to provide a coil electronic component with an improved breakdown voltage (BDV).

Further, the present disclosure attempts to provide a coil electronic component with improved electrode flatness and a sufficient MUF gap.

However, objects which the embodiments attempt to achieve are not limited to the above-mentioned object, and can be variously expanded without departing from the technical spirit and scope of the embodiments.

A coil electronic component according to an embodiment is a coil electronic component which includes a main body that has a first surface and a second surface which oppose each other in a first direction, a third surface and a fourth surface which oppose each other in a second direction and connect the first surface and the second surface, and a fifth surface and a sixth surface which oppose each other in a third direction and connect the first surface and the second surface, and includes a magnetic material, a coil at least a portion of which is embedded in the main body, an insulating layer disposed on the sixth surface of the main body, a first conductive layer that covers the sixth surface between the insulating layer and the first surface of the main body, a second conductive layer that covers the sixth surface between the insulating layer and the second surface of the main body, a first external electrode that covers the first conductive layer and is connected to the coil, a second external electrode that covers the second conductive layer. The coil electronic component may have a first length L1 in the first direction, and a second length L2 is a sum of a third length L3 in the first direction of a region where the insulating layer, the first conductive layer, and the first external electrode overlap and a fourth length L4 in the first direction of a region where the insulating layer, the second conductive layer, and the second external electrode overlap. A ratio L2/L1 may be 0.3 or more and 0.7 or less.

Further, the insulating layer may be spaced apart from the first surface and the second surface of the main body, respectively.

In addition, the first conductive layer and the second conductive layer may be spaced apart from each other, the first conductive layer may cover a portion of a surface of the insulating layer that is close to the first surface, and the second conductive layer may cover a portion of a surface of the insulating layer that is close to the second surface.

Further, the first external electrode may extend onto the first surface of the main body and is connected to the coil, and the second external electrode may extend onto the second surface of the main body and is connected to the coil.

In addition, the coil may be a wound coil.

Further, the coil electronic component may further include a support member that is disposed inside the main body and has a first support surface and a second support surface opposing each other, and the coil may include a first coil pattern on the first support surface of the support member, a second coil pattern on the second support surface of the support member, and a via that connects the first coil pattern and the second coil pattern.

Furthermore, the main body may include a laminate in which a plurality of sheets is stacked, and the coil may include a plurality of coil patterns disposed on each of the plurality of sheets and is connected to each other.

Moreover, one the first and second external electrodes may include a first metal layer that covers a corresponding one of the first and second conductive layers, a second metal layer that covers the first metal layer, and a third metal layer that covers the second metal layer.

In addition, the first metal layer may include copper (Cu), the second metal layer may include nickel (Ni), and the third metal layer may include tin (Sn).

A coil electronic component according to an embodiment is a coil electronic component which includes a main body that has a first surface and a second surface which oppose each other in a first direction, a third surface and a fourth surface which oppose each other in a second direction and connect the first surface and the second surface, and a fifth surface and a sixth surface which oppose each other in a third direction and connect the first surface and the second surface, and includes a magnetic material; a coil, at least a portion of which is embedded in the main body; an insulating layer disposed on the sixth surface of the main body; a conductive layer that covers a portion of the insulating layer on the sixth surface and is spaced apart from the first and second surfaces of the main body; and an external electrode that covers the conductive layer and a portion of the insulating layer and connects to the coil.

The coil electronic may further include another insulating layer disposed on the fifth surface of the main body.

The another insulating and the insulating layer may be spaced apart from each other.

Among the first to sixth surfaces of the main body, the conductive layer may be disposed only on the sixth surface.

The conductive layer may be in contact with the sixth surface of the main body.

The coil may include a lead-out portion extending to one of the first and second surfaces, and the external electrode may extend from the sixth surface to the one of the first and second surfaces to be in contact with the lead-out portion.

The external electrode may be in contact with the lead-out portion, the conductive layer, and the insulating layer.

The external electrode may include a first metal layer that covers the first conductive layer; a second metal layer that covers the first metal layer; and a third metal layer that covers the second metal layer.

The conductive layer may include a portion disposed between the insulating layer and the external electrode to be in contact with the insulating layer and the external electrode.

The conductive layer may include at least one of silver (Ag) powder, silver (Ag)-coated powder, copper (Cu) powder, or silver (Ag) alloy powder.

According to the embodiment, it is possible to provide a coil electronic component with an improved breakdown voltage (BDV).

Further, according to the embodiment, it is possible to provide a coil electronic component with improved electrode flatness and a sufficient MUF gap.

### BRIEF DESCRIPTION OF THE DRAWINGS

FIG. 1 is a perspective view schematically illustrating a coil electronic component according to an embodiment.

FIG. 2 is a schematic cross-sectional view taken along line II-II′ in FIG. 1.

FIG. 3 is a perspective view schematically illustrating a coil electronic component according to another embodiment.

FIG. 4 is a schematic cross-sectional view taken along line IV-IV′ in FIG. 3.

FIG. 5 is a cross-sectional view schematically illustrating a coil electronic component according to yet another embodiment.

### DETAILED DESCRIPTION OF THE EMBODIMENTS

Hereinafter, embodiments of the present invention will be described in detail with reference to the accompanying drawings such that those skilled in the art can easily implement them. The drawings and description are to be regarded as illustrative in nature and not restrictive. Like reference numerals designate like elements throughout the specification. Further, some constituent elements in the drawing may be exaggerated, omitted, or schematically illustrated, and a size of each constituent element does not reflect the actual size entirely.

The accompanying drawings are provided for helping to easily understand embodiments disclosed in the present specification, and the technical spirit disclosed in the present specification is not limited by the accompanying drawings, and it will be appreciated that the present invention includes all of the modifications, equivalent matters, and substitutes included in the spirit and the technical scope of the present invention.

Terms including an ordinary number, such as first and second, are used for describing various constituent elements, but the constituent elements are not limited by the terms. The terms are used only to discriminate one constituent element from another constituent element.

Further, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is “on” a reference portion, the element is located above or below the reference portion, and it does not necessarily mean that the element is located “above” or “on” in a direction opposite to gravity.

In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. Therefore, unless explicitly described to the contrary, the word “comprise”, and variations such as “comprises” or “comprising”, will be understood to imply the inclusion of stated elements but not the exclusion of any other elements.

Further, throughout the specification, when it is referred to as “on a plane”, it means when a target part is viewed from above, and when it is referred to as “on a cross-section”, it means when the cross-section obtained by cutting a target part vertically is viewed from the side.

Further, throughout the specification, when it is referred to as “connected”, this does not only mean that two or more constituent elements are directly connected, but may mean that two or more constituent elements are indirectly connected through another constituent element, are physically connected, electrically connected, or are integrated even though two or more constituent elements are referred as different names depending on a location and a function.

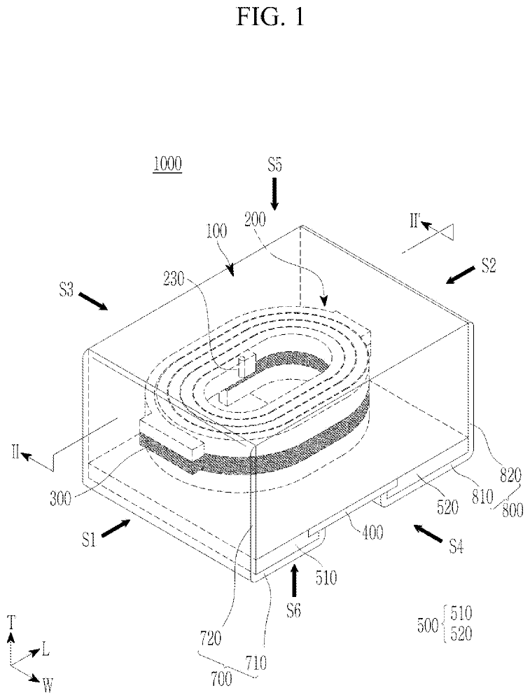

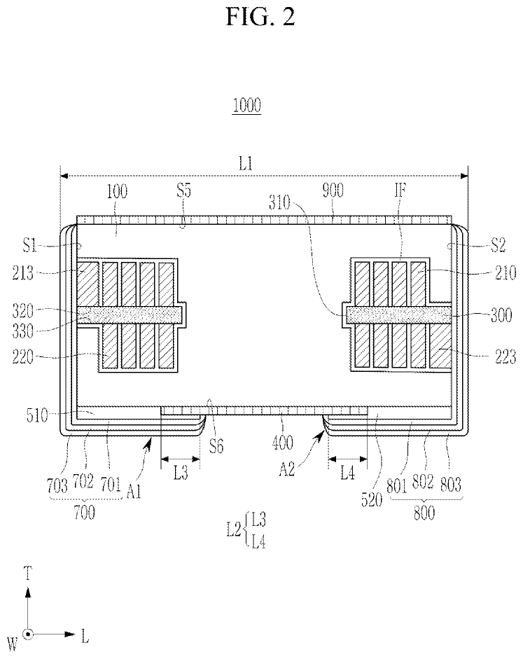

FIG. 1 is a perspective view schematically illustrating a coil electronic component according to an embodiment, and FIG. 2 is a schematic cross-sectional view taken along line II-II′ in FIG. 1.

Referring to FIG. 1 and FIG. 2, a coil electronic component 1000 according to an embodiment includes a main body 100, a coil 200, a support member 300, an insulating layer 400, a conductive layer 500, a first external electrode 700, and a second external electrode 800.

The main body 100 may have a substantially cuboid shape, but the present embodiment is not limited thereto. Due to shrinkage of magnetic powder during sintering, the main body 100 may have a substantially cuboid shape, although not a perfect cuboid shape. For example, the main body 100 may have a substantially cuboid shape but have rounded edges or vertices.

In the present embodiment, for ease of explanation, two surfaces of the main body opposing each other in the length direction (L-axis direction) are defined as a first surface S1 and a second surface S2, respectively, and two surfaces of the main body opposing each other in the width direction (W-axis direction) are defined as a third surface S3 and a fourth surface S4, respectively, and two surfaces of the main body opposing each other in the thickness direction (T-axis direction) are defined as a fifth surface S5 and a sixth surface S6, respectively.

A length of the coil electronic component 1000 may refer to the maximum value of the lengths of a plurality of line segments, each of which connects two outermost boundary lines of the coil electronic component 1000 facing each other in the length direction (L-axis direction), shown in an optical microscope photograph or SEM (Scanning Electron Microscope) photograph of a cross section taken in the length direction (L-axis direction) and thickness direction (T-axis direction) at a central portion of the coil electronic component 1000 in the width direction (W-axis direction), and is parallel to the length direction (L-axis direction). Alternatively, the length of the coil electronic component 1000 may refer to the minimum value of the lengths of a plurality of line segments, each of which connects two outermost boundary lines of the coil electronic component 1000 facing each other in the length direction (L-axis direction), shown in the above-mentioned cross section photograph and is parallel to the length direction (L-axis direction). Or, the length of the coil electronic component 1000 may refer to the arithmetic average of the lengths of at least two line segments of a plurality of line segments, each of which connects two outermost boundary lines of the coil electronic component 1000 facing each other in the length direction (L-axis direction), shown in the above-mentioned cross section photograph and is parallel with the length direction (L-axis direction).

A thickness of the coil electronic component 1000 may refer to the maximum value of the lengths of a plurality of line segments, each of which connects two outermost boundary lines of the coil electronic component 1000 facing each other in the thickness direction (T-axis direction), shown in an optical microscope photograph or SEM (Scanning Electron Microscope) photograph of a cross section taken in the length direction (L-axis direction) and thickness direction (T-axis direction) at a central portion of the coil electronic component 1000 in the width direction (W-axis direction), and is parallel to the thickness direction (T-axis direction). Alternatively, the thickness of the coil electronic component 1000 may refer to the minimum value of the lengths of a plurality of line segments, each of which connects two outermost boundary lines of the coil electronic component 1000 facing each other in the thickness direction (T-axis direction), shown in the above-mentioned cross section photograph and is parallel to the thickness direction (T-axis direction). Or, the thickness of the coil electronic component 1000 may refer to the arithmetic average of the lengths of at least two line segments of a plurality of line segments, each of which connects two outermost boundary lines of the coil electronic component 1000 facing each other in the thickness direction (T-axis direction), shown in the above-mentioned cross section photograph and is parallel to the thickness direction (T-axis direction).

A width of the coil electronic component 1000 may refer to the maximum value of the lengths of a plurality of line segments, each of which connects two outermost boundary lines of the coil electronic component 1000 facing each other in the width direction (W-axis direction), shown in an optical microscope photograph or SEM (Scanning Electron Microscope) photograph of a cross section taken in the length direction (L-axis direction) and width direction (W-axis direction) at a central portion of the coil electronic component 1000 in the thickness direction (T-axis direction), and is parallel to the width direction (W-axis direction). Alternatively, the width of the coil electronic component 1000 may refer to the minimum value of the lengths of a plurality of line segments, each of which connects two outermost boundary lines of the coil electronic component 1000 facing each other in the width direction (W-axis direction), shown in the above-mentioned cross section photograph and is parallel to the width direction (W-axis direction). Or, the width of the coil electronic component 1000 may refer to the arithmetic average of the lengths of at least two line segments of a plurality of line segments, each of which connects two outermost boundary lines of the coil electronic component 1000 facing each other in the width direction (W-axis direction), shown in the above-mentioned cross section photograph and is parallel to the width direction (W-axis direction).

Further, each of the length, width, and thickness of the coil electronic component 1000 may be measured using a micrometer measurement method. In the micrometer measurement method, a zero point is set with a micrometer providing repeatability and reproducibility (Gage R&R), the coil electronic component 1000 according to the present embodiment is inserted between tips of the micrometer, and a measuring lever of the micrometer is turned for the measurement. Meanwhile, when measuring the length of the coil electronic component 1000 by the micrometer measurement method, the length of the coil electronic component 1000 may refer to a value obtained by a single measurement, or may refer to an arithmetic average of values obtained by a plurality of measurements. The same may be equally applied to measuring the width and thickness of the coil electronic component 1000.

The main body 100 constitutes an exterior of the coil electronic component 1000, and has a space where a magnetic path, which is a path through which the magnetic flux induced by the coil 200 passes, is formed, when current is applied to the coil 200 through the first external electrode 700 and the second external electrode 800.

The main body 100 surrounds and encapsulates the coil 200 and the support member 300, and includes a magnetic material. The main body 100 includes magnetic particles, and an insulating material in which the magnetic particles are dispersed.

The magnetic material may include a first metal magnetic powder, a second metal magnetic powder having a particle diameter larger than that of the first metal magnetic powder, and a third metal magnetic powder having a particle diameter larger than that of the second metal magnetic powder. The average particle diameter D₅₀ of the first metal magnetic powder may be in a range from 0.1 μm to 0.2 μm, and the average particle diameter D₅₀ of the second metal magnetic powder may be in a range from 1 μm to 2 μm, and the average particle diameter D₅₀ of the third metal magnetic powder may be in a range from 25 μm to 30 μm.

The magnetic particles may be ferrite particles or metal magnetic particles that exhibit magnetic properties.

The ferrite particles may include, for example, at least one of spinel-type ferrites such as Mg—Zn-based ferrites, Mn—Zn-based ferrites, Mn—Mg-based ferrites, Cu—Zn-based ferrites, Mg—Mn—Sr-based ferrites, and Ni—Zn-based ferrites, hexagonal ferrites such as Ba—Zn-based ferrites, Ba—Mg-based ferrites, Ba—Ni-based ferrites, Ba—Co-based ferrites, and Ba—Ni—Co-based ferrites, garnet-type ferrites such as Y-based ferrites, and Li-based ferrites.

The metal magnetic particles may comprise two or more types of powder particles having different compositions, and may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the metal magnetic particles may be at least one of pure iron, Fe—Si-based alloys, Fe—Si—Al-based alloys, Fe—Ni-based alloys, Fe—Ni—Mo-based alloys, Fe—Ni—Mo—Cu-based alloys, Fe—Co-based alloys, Fe—Ni—Co-based alloys, Fe—Cr-based alloys, Fe—Cr—Si-based alloys, Fe—Si—Cu—Nb-based alloys, Fe—Ni—Cr-based alloys, and Fe—Cr—Al-based alloys. Here, it may also mean that different compositions of metal magnetic particles mean different contents.

The metal magnetic particles may be amorphous or crystalline. For example, the metal magnetic particles may be an Fe—Si—B—Cr-based amorphous alloy, but the present embodiment is not limited thereto. The metal magnetic particles may have an average particle diameter of about 0.1 μm to 30 μm, but are not limited thereto. In this specification, an average particle diameter may refer to a particle size distribution expressed as D₉₀, D₅₀, etc. The particle size distribution is well known to those skilled in the art as an indicator of what proportion of particles of what size (particle diameters) are contained within a population of particles to be measured. D₅₀ (a particle diameter corresponding to 50% of the cumulative volume of a particle size distribution) refers to an average particle diameter.

The metal magnetic particles may be two or more types of different metal magnetic particles. Herein, that the types of the metal magnetic particles are different means that the metal magnetic particles are distinguished from each other in at least one of average particle diameter, composition, component ratio, crystallinity, and shape.

The insulating material may contain epoxy, polyimide, liquid crystal polymer, etc., either alone or in combination, but is not limited thereto.

The method of forming the main body 100 is not particularly limited. For example, the main body 100 may be formed by placing sheets of a magnetic material on the upper and lower portions of the coil 200 and then pressing and curing the sheets.

The support member 300 is disposed inside the main body 100, and supports the coil 200.

The support member 300 may be made of an insulating material including a thermosetting insulating resin such as epoxy resin, a thermoplastic insulating resin such as polyimide, or a photosensitive insulating resin, or may be made of an insulating material in which the above-described insulating resin is impregnated with a reinforcing member such as glass fiber or inorganic filler. For example, the support member 300 may be made of an insulating material such as prepreg, Ajinomoto Build-up Film (ABF), FR-4, Bismaleimide Triazine (BT) film, Photo Imageable Dielectric (PID) film, etc., but the present embodiment is not limited thereto.

Inorganic fillers may include at least one selected from the group consisting of silica (SiO₂), alumina (Al₂O₃), silicon carbide (SiC), barium sulfate (BaSO₄), talc, clay, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

There is a through-hole 310 at the center of the support member 300. The through-hole 310 may be filled with a magnetic material that comprises the main body 100 to form a core, thereby improving the performance of the coil electronic component.

The coil 200 is disposed inside the main body 100, thereby exhibiting the characteristics of the coil electronic component 1000. For example, when the coil electronic component 1000 of the present embodiment is utilized as a power inductor, when current is applied to the coil 200, the coil electronic component may serve to stabilize the power source of the electronic device by storing energy in the form of a magnetic field and maintaining the output voltage.

The coil 200 may be disposed on a first support surface 320 and a second support surface 330 of the support member 300 opposing each other. The coil 200 may include a first coil pattern 210 and a second coil pattern 220, and the first coil pattern 210 and the second coil pattern 220 may be electrically connected to each other via a via 230.

The first coil pattern 210 is disposed on the first support surface 320 of the support member 300, and includes a first lead-out portion 213. The first lead-out portion 213 is exposed from the first surface S1 of the main body 100, and is electrically connected to the first external electrode 700.

The second coil pattern 220 is disposed on the second support surface 330 of the support member 300, and includes a second lead-out portion 223. The second lead-out portion 223 is exposed from the second surface S2 of the main body 100, and is electrically connected to the second external electrode 800.

Meanwhile, when the first coil pattern 210, the first lead-out portion 213, and the via 230 are plated on the first support surface 320 of the support member 300, the first coil pattern 210, the first lead-out portion 213, and the via 230 may each include a seed layer, such as an electroless plating layer, and an electroplating layer. Here, the electroplating layer may have a single-layered structure or may have a multi-layered structure. The multi-layered electroplating layer may be formed as a conformal film structure with one electroplating layer covering the other, or as a stacked structure with only on one electroplating layer stacked only on one side of the other. A seed layer of the first coil pattern 210, a seed layer of the first lead-out portion 213, and a seed layer of the via 230 may be integrally formed and thus there may be no boundary therebetween, but the present embodiment is not limited thereto. An electroplating layer of the first coil pattern 210, an electroplating layer of the first lead-out portion 213, and an electroplating layer of the via 230 may be integrally formed and thus there may be no boundary therebetween, but the present embodiment is not limited thereto. The above description may be equally applied to the second coil pattern 220, the second lead-out portion 223, and the via 230.

The coil 200 and the via 230 each may be made of a conductive material such as copper (Cu), aluminum (Al), silver (Ag), tin (Sn), gold (Au), nickel (Ni), lead (Pb), titanium (Ti), or an alloy thereof, but the present embodiment is not limited thereto.

An insulating film IF may be disposed between the coil 200 and the main body 100. The insulating film IF may be disposed along surfaces of the support member 300 and the coil 200. The insulating film IF is not present where the support member 300 and the coil 200 are connected to the external electrodes 700 and 800. The insulating film IF is for insulating the coil 200 from the main body 100, and may include a known insulating material such as parylene. Any insulating material may be included in the insulating film IF, and there is no particular limitation. For example, the insulating film IF may be a polyurethane resin, a polyester resin, an epoxy resin, or a polyamideimide resin. The insulating film IF may be formed by a method such as vapor deposition, but is not limited thereto. For example, the insulating film IF may be formed by laminating insulating films on both surfaces of the support member 300.

The insulating layer 400 may be disposed on the sixth surface S6 of the main body 100. The insulating layer 400 may be spaced apart from the first surface S1 and the second surface S2 of the main body 100, respectively. In other words, the insulating layer 400 may partially cover the sixth surface S6 of the main body 100.

The insulating layer 400 may include a thermoplastic resin, such as polystyrene-based resins, vinyl acetate-based resins, polyester-based resins, polyethylene-based resins, polypropylene-based resins, polyamide-based resins, rubber-based resins, acrylic-based resins, and the like, a thermosetting resin, such as phenol-based resins, epoxy-based resins, urethane-based resins, melamine-based resins, alkyd-based resins, and the like, photosensitive resins, parylene, SiOx, or SiNₓ.

The insulating layer 400 may be formed by a process such as screen printing, pad printing, dipping, spray printing, etc. For example, the insulating layer 400 may be formed by applying liquid insulating resin to the surface of the main body 100, by laminating an insulating film such as dry film on the surface of the main body 100, or by a thin film process such as vapor deposition. For insulating film, it does not matter if an Ajinomoto Build-up Film (ABF) or polyimide film, and so on that does not contain photosensitive insulating resin is used.

A thickness of the insulating layer 400 may be in a range from 3 μm to 25 μm. If the thickness of the insulating layer 400 is smaller than 3 μm, the insulating performance may be degraded, resulting in a decrease in the breakdown voltage. If the thickness of the insulating layer 400 exceeds 25 μm, the increase in breakdown voltage is limited, while the coil electronic component 1000 is too thick, resulting in poor mounting or loss of electrical characteristics.

The conductive layer 500 may cover portions of the insulating layer 400, and may include a first conductive layer 510 and a second conductive layer 520.

The first conductive layer 510 and the second conductive layer 520 may be spaced apart from each other, and may each cover a portion of the insulating layer 400.

The first conductive layer 510 may partially cover the sixth surface S6 of the main body 100. In other words, the first conductive layer 510 may cover the region between the insulating layer 400 and the first surface S1 on the sixth surface S6 of the main body 100.

The first conductive layer 510 may cover a portion of an outer surface of the insulating layer 400 that is relatively close to the first surface S1 of the main body 100. Here, the outer surface of the insulating layer 400 refers to a surface opposite the surface in contact with the main body 100, i.e., an inner surface of the insulating layer 400. The outer surface of the insulating layer 400 may be roughly divided into two portions based on the center portion of the insulating layer 400, i.e., a surface closer to the first surface S1 and a surface closer to the second surface S2 of the main body 100. The first conductive layer 510 may partially cover a portion of the surface of the insulating layer 400 closer to the first surface S1.

The second conductive layer 520 may partially cover the sixth surface S6 of the main body 100. In other words, the second conductive layer 520 may cover the region between the insulating layer 400 and the second surface S2 on the sixth surface S6 of the main body 100.

The second conductive layer 520 may cover a portion of the outer surface of the insulating layer 400 that is relatively close to the second surface S2 of the main body 100. In other words, the second conductive layer 520 may partially cover a portion of the surface of the insulating layer 400 closer to the second surface S2.

As described above, both surfaces relative to the center portion of the insulating layer 400 may be partially covered by the first conductive layer 510 and the second conductive layer 520, respectively. In other words, the center portion of the insulating layer 400 is not covered by the conductive layer 500.

Both edges of the insulating layer 400 may be in contact with the first conductive layer 510 and the second conductive layer 520, respectively. The region between the edge closer to the first surface S1 of the main body 100, of the two edges of the insulating layer 400, and the first surface S1 of the main body 100 may be covered by the first conductive layer 510. The region between the edge closer to the second surface S2 of the main body 100, of the two edges of the insulating layer 400, and the second surface S2 of the main body 100 may be covered by the second conductive layer 520.

The first and second conductive layers 510 and 520 may function as seed layers for forming the first and second external electrodes 700 and 800 by plating. In other words, the first external electrode 700 may be formed by directly plating a conductive metal on the first conductive layer 510, and the second external electrode 800 may be formed by directly plating a conductive metal on the second conductive layer 520. As described above, the first and second external electrodes 700 and 800 formed by the direct plating method of growing the conductive metal with the first and second conductive layers 510 and 520 as seed layers have a high degree of flatness and a correspondingly sufficient MUF gap.

The first and second conductive layers 510 and 520 may be formed through a process such as screen printing, pad printing, dipping, spray printing, etc. The composition of the conductive layer may include materials such as silver (Ag) powder, silver (Ag)-coated powder, copper (Cu) powder, or silver (Ag) alloy powder.

A thickness of the first and second conductive layers 510 and 520 may each be in a range from 1 μm to 25 μm. If the thickness of the first and second conductive layers 510 and 520 is smaller than 1 μm, they are too thin to serve as a sufficient seed layer. In other words, there may be areas where the plating layer is not formed and the external electrodes may not be formed with sufficient thickness. If the thickness of the first and second conductive layers 510 and 520 exceeds 25 μm, the coil electronic component 1000 may be too thick, resulting in poor mounting or degraded electrical characteristics.

The first external electrode 700 and the second external electrode 800 are disposed outside the main body 100, and are connected to the coil 200. In other words, the first external electrode 700 and the second external electrode 800 are connected to the first lead-out portion 213 and the second lead-out portion 223 of the coil 200, respectively.

The first external electrode 700 extends from the sixth surface S6 of the main body 100 onto a portion of the first surface S1 and is connected to the first lead-out portion 213 of the coil 200.

For example, the first external electrode 700 may include a first electrode pad 710 and a first connection portion 720.

The first electrode pad 710 is disposed on the sixth surface S6 of the main body 100, and the first connection portion 720 extends from the first electrode pad 710 onto the first surface S1 of the main body 100. The first lead-out portion 213 of the coil 200 is exposed from the first surface S1 of the main body 100 and is connected to the first connection portion 720. Accordingly, the coil 200 is electrically connected to the first external electrode 700.

The first electrode pad 710 and the first connection portion 720 may be an integral structure. For example, the first electrode pad 710 and the first connection portion 720 may be formed by plating.

The second external electrode 800 extends from the sixth surface S6 of the main body 100 onto a portion of the second surface S2, and is connected to the second lead-out portion 223 of the coil 200.

For example, the second external electrode 800 may include a second electrode pad 810 and a second connection portion 820.

The second electrode pad 810 is disposed on the sixth surface S6 of the main body 100, and the second connection portion 820 extends from the second electrode pad 810 onto the second surface S2 of the main body 100. The second lead-out portion 223 of the coil 200 is exposed from the second surface S2 of the main body 100 and is connected to the second connection portion 820. Accordingly, the coil 200 is electrically connected to the second external electrode 800.

The second electrode pad 810 and the second connection portion 820 may be an integral structure. For example, the second electrode pad 810 and the second connection portion 820 may be formed by plating.

The first external electrode 700 may include a first metal layer 701, a second metal layer 702, and a third metal layer 703.

The first metal layer 701 is a plating layer in contact with the first lead-out portion 213 of the coil 200 and the outer surface of the main body 100, i.e., the first surface S1, and may include copper (Cu). Further, the first metal layer 701 may cover the first conductive layer 510. Meanwhile, the first metal layer 701 may extend beyond the first conductive layer 510 and be in contact with a portion of the insulating layer 400. The first metal layer 701 may constitute the first electrode pad 710 and the first connection portion 720 of the first external electrode 700.

The second metal layer 702 may be a plating layer that covers the first metal layer 701, and may include nickel (Ni). The third metal layer 703 may be a plating layer that covers the second metal layer 702, and may include tin (Sn). However, the present embodiment is not limited to such a three-layer structure, and a two-layer structure with only one metal layer added to the first metal layer 701 is also possible.

The second external electrode 800 may include a first metal layer 801, a second metal layer 802, and a third metal layer 803.

The first metal layer 801 may be a plating layer in contact with the second lead-out portion 223 of the coil 200 and the outer surface of the main body 100, i.e., the second surface S2, and may include copper (Cu). Further, the first metal layer 801 may cover the second conductive layer 520. Meanwhile, the first metal layer 801 may extend beyond the second conductive layer 520 and be in contact with a portion of the insulating layer 400. The first metal layer 801 may constitute the second electrode pad 810 and the second connection portion 820 of the second external electrode 800.

The second metal layer 802 may be a plating layer that covers the first metal layer 801, and may include nickel (Ni). The third metal layer 803 may be a plating layer that covers the second metal layer 802, and may include tin (Sn). However, the present embodiment is not limited to such a three-layer structure, and a two-layer structure with only one metal layer added to the first metal layer 801 is also possible.

As described above, portions of the insulating layer 400 are covered by the first conductive layer 510 and the second conductive layer 520, and the first conductive layer 510 is covered by the first external electrode 700, and the second conductive layer 520 is covered by the second external electrode 800. Accordingly, the insulating layer 400, the conductive layer 500, and the external electrodes 700 and 800 may form a three-layer structure. That is, there is a first overlap region A1 where the insulating layer 400, the first conductive layer 510, and the first external electrode 700 all overlap, and a second overlap region A2 where the insulating layer 400, the second conductive layer 520, and the second external electrode 800 all overlap. Hereinafter, when the first overlap region A1 and the second overlap region A2 are collectively referred to, they will be referred to as the “overlap region”.

When the coil electronic component 1000 has a first length L1, the overlap region has a second length L2, and the ratio of the second length L2 to the first length L1 may be within a certain range.

The first overlap region A1 has a third length L3, and the second overlap region A2 has a fourth length L4. Accordingly, the second length L2 of the overlap region is the sum of the third length L3 of the first overlap region A1 and the fourth length L4 of the second overlap region A2.

The ratio L2/L1 of the second length L2 of the overlap regions to the first length L1 of the coil electronic component 1000 (hereinafter, referred to as the “ratio of the overlap region”) may be in a range from 0.3 to 0.7.

If the ratio L2/L1 of the overlap region is smaller than 0.3, the effect of blocking the leakage current between the coil and the external electrodes may not be large, and the effect of increasing the breakdown voltage may not be large.

If the ratio L2/L1 of the overlap region exceeds 0.7, the first external electrode 700 and the second external electrode 800 may become too close to each other, resulting in a large potential for current leakage and a decrease in the breakdown voltage.

Here, L1 may refer to the maximum value of the lengths of a plurality of line segments, each of which connects two outermost boundary lines of the coil electronic component 1000 facing each other in the length direction (L-axis direction), shown in an optical microscope photograph or SEM (Scanning Electron Microscope) photograph of a cross section taken in the length direction (L-axis direction) and thickness direction (T-axis direction) at the center of the coil electronic component 1000 in the width direction (W-axis direction), and is parallel to the length direction (L-axis direction). L3 may refer to the distance between two straight lines perpendicular to the length direction (L-axis direction) and passing through both edges of the region where the insulating layer 400, the first conductive layer 510, and the first external electrode 700 shown in the above-mentioned cross section photograph overlap. L4 may refer to the distance between two straight lines perpendicular to the length direction (L-axis direction) and passing through both edges of the region where the insulating layer 400, the second conductive layer 520, and the second external electrode 800 shown in the above-mentioned cross section photograph overlap. L2 may refer to the sum of L3 and L4 as described above.

As described above, the insulating layer 400 may be disposed on the sixth surface S6 of the main body 100, but the insulating layer 900 may also be disposed on other portions of the main body 100. For example, the insulating layer 900 may be disposed on the third surface S3, the fourth surface S4, and the fifth surface S5 of the main body 100. Further, when the first external electrode 700 partially covers the first surface S1 of the main body 100 and the second external electrode 800 partially covers the second surface S2 of the main body 100, the insulating layer 900 may also be disposed on the remaining portion of the first surface S1 and the remaining portion of the second surface S2.

As described above, the insulating layer 900 may be disposed on at least portions of the first surface S1, the second surface S2, the third surface S3, the fourth surface S4, the fifth surface S5, and the sixth surface S6 of the main body 100 to prevent electrical shorts between other electronic components and the external electrodes 700 and 800.

The insulating layer 900 may be utilized as a resist when forming the external electrodes 700 and 800 by electroplating, but is not limited thereto.

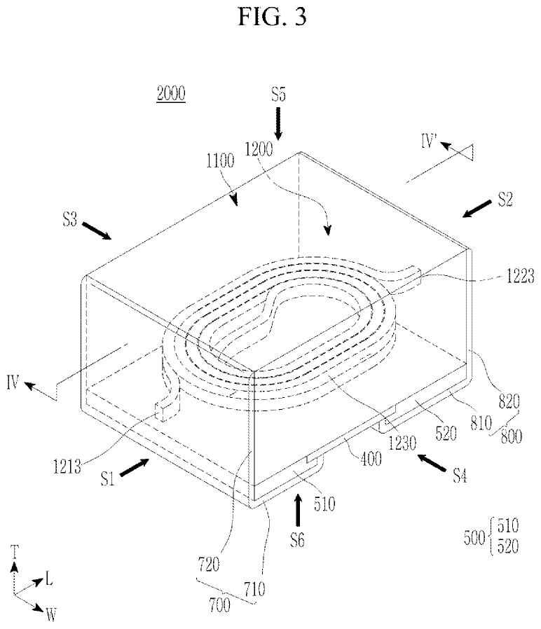

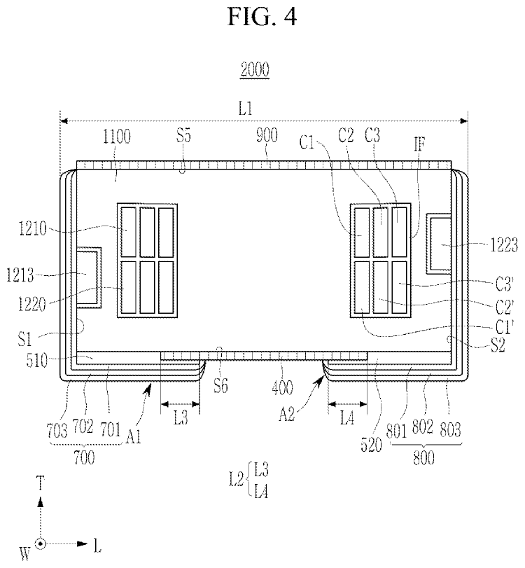

FIG. 3 is a perspective view schematically illustrating a coil electronic component according to another embodiment, and FIG. 4 is a schematic cross-sectional view taken along line IV-IV′ in FIG. 3.

Referring to FIG. 3 and FIG. 4, a coil electronic component 2000 according to an embodiment includes a main body 1100, a coil 1200, an insulating layer 400, a conductive layer 500, a first external electrode 700, and a second external electrode 800.

The coil 1200 may include at least one turn of conductive wire. For example, the coil 1200 may be in the form of a spiral wound metal (for example, copper (Cu) or silver (Ag)) wire with a surface covered with an insulating material. In other words, the coil 1200 may be a wound coil. The coil 1200 is not limited to a single wire, but may consist of a stranded wire, or two or more wires.

The coil 1200 may be a circular coil, but is not limited thereto. For example, the coil 1200 may be various known coils such as a rectangular coil.

A cross section of each wire of the coil 1200 may have various known shapes such as a square, a circle, an oval, a triangle, etc.

The coil 1200 may comprise a plurality of layers. The coil 1200 may include a first coil 1210 and a second coil 1220. The first coil 1210 may be connected to the second coil 1220, and disposed on the upper side of the second coil 1220, i.e., on the fifth surface (S5) side of the main body 1100, to comprise a layer.

The number of turns of the first coil 1210 and the number of turns of the second coil 1220 may be the same as or different from each other.

The coil 1200 may be shaped as a planar spiral, and have a plurality of turns. For example, the first coil 1210 may have an innermost turn coil C1, at least one intermediate turn coil C2, and an outermost turn coil C3 sequentially from the inner side to the outer side of the main body 1100. The second coil 1220 may also have an innermost turn coil C1′, at least one intermediate turn coil C2′, and an outermost turn coil C3′ sequentially from the inner side to the outer side of the main body 1100.

An insulating film IF may be disposed along a surface of each of the plurality of turns of the coil 1200. The insulating film IF is for protecting and insulating the plurality of turns of the first coil 1210 and the second coil 1220, and may include a known insulating material such as parylene. Any insulating material may be included in the insulating film IF, and there is no particular limitation. For example, the insulating film IF may be a polyurethane resin, a polyester resin, an epoxy resin, or a polyamideimide resin. The insulating film IF may be formed by a method such as vapor deposition, but is not limited thereto.

The coil 1200 may include a wound portion 1230, a first lead-out portion 1213, and a second lead-out portion 1223.

The wound portion 1230 is a portion where the metal wire comprises at least one turn.

The first lead-out portion 1213 extends from one end of the wound portion 1230 and is exposed from the first surface S1 of the main body 1100. The first lead-out portion 1213 is connected to the first external electrode 700. The second lead-out portion 1223 extends from the other end of the wound portion 1230 and is exposed from the second surface S2 of the main body 1100. The second lead-out portion 1223 is connected to the second external electrode 800.

Except for the above-described components, the remaining components are identical to those of the coil electronic component shown in FIG. 1, and thus a redundant description thereof will be omitted.

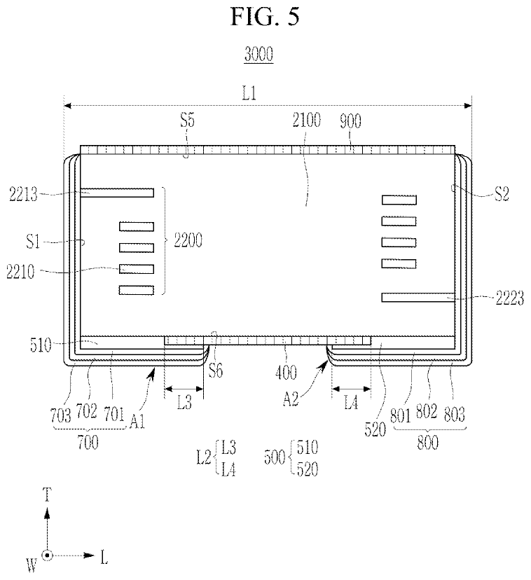

FIG. 5 is a cross-sectional view schematically illustrating a coil electronic component according to yet another embodiment.

Referring to FIG. 5, a coil electronic component 3000 includes a main body 2100, a coil 2200, an insulating layer 400, a conductive layer 500, a first external electrode 700, and a second external electrode 800.

The main body 2100 may be a laminate in which a plurality of sheets comprising a magnetic material is stacked in the thickness direction (T-axis direction). The coil 2200 may include a plurality of coil patterns 2210 disposed on each sheet and connected to each other.

At one end of the coil 2200, a first lead-out portion 2213 is disposed, and at the other end, a second lead-out portion 2223 is disposed. The first lead-out portion 2213 is exposed from the first surface S1 of the main body 2100 and connected to the first external electrode 700. The second lead-out portion 2223 is exposed from the second surface S2 of the main body 2100 and connected to the second external electrode 800.

Except for the above-described components, the remaining components are identical to those of the coil electronic component shown in FIG. 1, and thus a redundant description thereof will be omitted.

Hereinafter, specific embodiments of the present disclosure will be presented. However, the following embodiments are intended only to illustrate or describe the disclosure and should not be construed as liming the scope of the disclosure.

### Preparation Example: Manufacture of Coil Electronic Components

### Comparative Example 1

Coil electronic components are manufactured such that the first length L1 is 2500 μm and the second length L2 of the overlap region is 0 μm.

### Comparative Example 2

Comparative Example 2 is identical to Comparative Example 1 except that the first length L1 is 2500 μm and the second length L2 of the overlap region is 250 μm.

### Comparative Example 3

Comparative Example 3 is identical to Comparative Example 1 except that the first length L1 is 2500 μm and the second length L2 of the overlap region is 500 μm.

### Example 1

Coil electronic components are manufactured such that the first length L1 is 2500 μm and the second length L2 of the overlap region is 750 μm.

### Example 2

Example 2 is identical to Example 1 except that the first length L1 is 2500 μm and the second length L2 of the overlap region is 1230 μm.

### Example 3

Example 3 is identical to Example 1 except that the first length L1 is 2500 μm and the second length L2 of the overlap region is 1700 μm.

### Comparative Example 4

Comparative Example 4 is identical to Comparative Example 1 except that the first length L1 is 2500 μm and the second length L2 of the overlap region is 1850 μm.

### Comparative Example 5

Comparative Example 5 is identical to Comparative Example 1 except that the first length L1 is 2500 μm and the second length L2 of the overlap region is 2000 μm.

### Experimental Example: Breakdown Voltage Stability of Coil Electronic Components

After 50 pieces of coil electronic components according to each of Examples 1 to 3 and Comparative Examples 1 to 5 were manufactured, the ratio (L2/L1) of the second length L2 of the overlap region to the first length L1 of the coil electronic component and the breakdown voltage were measured, and the breakdown voltage stability were determined based on the minimum breakdown voltage BDVₘᵢₙ. In other words, if the BDVₘᵢₙ was smaller than 200 V, the stability was determined to be “poor”, and if the BDVₘᵢₙ was equal to or greater than 200 V, the stability was determined to be “good”. The results were summarized in Table 1.

TABLE 1

| | L1 | L2 | | Breakdown Voltage |
|---|---|---|---|---|
| | (μm) | (μm) | L2/L1 | Stability |
| Comparative | 2500 | 0 | 0.00 | poor |
| Example 1 | | | | |
| Comparative | 2500 | 250 | 0.10 | poor |
| Example 2 | | | | |
| Comparative | 2500 | 500 | 0.20 | poor |
| Example 3 | | | | |
| Example 1 | 2500 | 750 | 0.30 | good |
| Example 2 | 2500 | 1230 | 0.49 | good |
| Example 3 | 2500 | 1700 | 0.68 | good |
| Comparative | 2500 | 1850 | 0.74 | poor |
| Example 4 | | | | |
| Comparative | 2500 | 2000 | 0.80 | poor |
| Example 5 | | | | |

Referring to Table 1, in the coil electronic components manufactured according to Examples 1 to 3, the minimum breakdown voltages were 200 V or more, and thus the breakdown voltage stability was determined to be good. In the coil electronic components manufactured according to Comparative Examples 1 to 5, the minimum breakdown voltages were smaller than 200 V, and thus the breakdown voltage stability was determined to be poor. This is because the ratio (L2/L1) of the second length L2 of the overlap region to the first length L1 of the coil electronic components was smaller than 0.3 (Comparative Examples 1 and 2) or greater than 0.7 (Comparative Examples 4 and 5).

### Experimental Examples: Electrode Flatness and MUF Gap of Coil Electronic Components

After 10 pieces of coil electronic components according to each of Example 1 and Comparative Example 1 were manufactured, and the ten point height of roughness profile Rz of the external electrodes and the magnitudes of the MUF gaps were measured, and the results are summarized in Table 2.

A ten point height of roughness profile of an electrode is a measure of the degree of electrode flatness, and the smaller the value, the more flat the electrode. When electrodes are flat, the contact area with lands (electrodes for mounting) increase, which is advantageous for substrate mounting.

A MUF gap refers to the size of a gap between an insulating band portion (the area between a first external electrode and a second external electrode) of a coil electronic component and a substrate when the coil electronic component is mounted on the substrate. In modularized conditions such as SiP (System in Package), a number of element components are mounted, and then are encapsulated with an encapsulating material such as EMC (Epoxy Molding Compound), liquid underfill, etc., through a packaging process. In this case, it is required to secure a sufficient space (20±5 μm) between MUF gaps. For example, if the MUF gap is 5 μm or less, the gap between the coil electronic component and the substrate is too small, making it difficult for the encapsulating material to flow and reducing fillability, which may cause voids to form. The generated voids may exist as defects in the package, and may cause a number of failures such as poor thermal and mechanical reliability. Further, if the MUF gap is 0 km or less, there is a possibility that the coil electronic component may be misplaced or lifted when mounted on a substrate, causing one external electrode of the coil electronic component is fixed to the substrate while the other external electrode stands up off the substrate (Manhattan effect or Tombstone defect).

TABLE 2

| Ten Point Height of | |
|---|---|
| Roughness Profile (Rz) | MUF Gap (μm) |

| | | Comparative | | Comparative |
|---|---|---|---|---|
| | Example 1 | Example 1 | Example 1 | Example 1 |
| 1 | 0.7 | 4.3 | 25.2 | −1.5 |
| 2 | 1.1 | 5.2 | 23.4 | 8.8 |
| 3 | 0.9 | 6 | 24.5 | 4 |
| 4 | 0.7 | 4.7 | 24.3 | 7.2 |
| 5 | 0.8 | 4.5 | 24.3 | 1.5 |
| 6 | 1.2 | 4.3 | 22.8 | 6.2 |
| 7 | 0.9 | 5.5 | 25.6 | 4.7 |
| 8 | 0.7 | 7.2 | 23.2 | 6.3 |
| 9 | 0.6 | 3.9 | 24.3 | 3.9 |
| 10 | 0.8 | 4.1 | 22.4 | −2.7 |

Referring to Table 2, the coil electronic components manufactured according to Example 1 exhibited a lower level of ten point heights of roughness profiles (RZ) compared with the coil electronic components manufactured according to Comparative Example 1. It can be seen that the flatness of the external electrodes of the coil electronic components manufactured according to Example 1 has been improved. It can also be seen that for the coil electronic components manufactured according to Example 1, sufficient MUF gap is achieved.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

What is claimed is:

1. A coil electronic component comprising:
a main body that has a first surface and a second surface which oppose each other in a first direction, a third surface and a fourth surface which oppose each other in a second direction and connect the first surface and the second surface, and a fifth surface and a sixth surface which oppose each other in a third direction and connect the first surface and the second surface, and includes a magnetic material;
a coil, at least a portion of which is embedded in the main body;
an insulating layer disposed on the sixth surface of the main body;
a first conductive layer that covers the sixth surface between the insulating layer and the first surface of the main body;
a second conductive layer that covers the sixth surface between the insulating layer and the second surface of the main body;
a first external electrode that covers the first conductive layer; and
a second external electrode that covers the second conductive layer,
wherein the coil electronic component has a first length L1 in the first direction, and a second length L2 is a sum of a third length L3 in the first direction of a region where the insulating layer, the first conductive layer, and the first external electrode overlap and a fourth length L4 in the first direction of a region where the insulating layer, the second conductive layer, and the second external electrode overlap, and
a ratio L2/L1 is 0.3 or more and 0.7 or less.

2. The coil electronic component of claim 1, wherein
the insulating layer is spaced apart from the first surface and the second surface of the main body, respectively.

3. The coil electronic component of claim 1, wherein
the first conductive layer and the second conductive layer are spaced apart from each other,
the first conductive layer covers a portion of a surface of the insulating layer that is close to the first surface, and
the second conductive layer covers a portion of a surface of the insulating layer that is close to the second surface.

4. The coil electronic component of claim 1, wherein
the first external electrode extends onto the first surface of the main body and is connected to the coil, and
the second external electrode extends onto the second surface of the main body and is connected to the coil.

5. The coil electronic component of claim 1, wherein
the coil is a wound coil.

6. The coil electronic component of claim 1, further comprising:
a support member that is disposed inside the main body and has a first support surface and a second support surface opposing each other,
wherein the coil includes a first coil pattern on the first support surface of the support member, a second coil pattern on the second support surface of the support member, and a via that connects the first coil pattern and the second coil pattern.

7. The coil electronic component of claim 1, wherein
the main body includes a laminate in which a plurality of sheets is stacked, and
the coil includes a plurality of coil patterns disposed on each of the plurality of sheets and connected to each other.

8. The coil electronic component of claim 1, wherein
one of the first and second external electrodes includes:
a first metal layer that covers a corresponding one of the first and second conductive layers;
a second metal layer that covers the first metal layer; and
a third metal layer that covers the second metal layer.

9. The coil electronic component of claim 8, wherein
the first metal layer includes copper (Cu),
the second metal layer includes nickel (Ni), and
the third metal layer includes tin (Sn).

10. A coil electronic component comprising:
a main body that has a first surface and a second surface which oppose each other in a first direction, a third surface and a fourth surface which oppose each other in a second direction and connect the first surface and the second surface, and a fifth surface and a sixth surface which oppose each other in a third direction and connect the first surface and the second surface, and includes a magnetic material;
a coil, at least a portion of which is embedded in the main body;
an insulating layer disposed on the sixth surface of the main body;
a conductive layer that covers a portion of the insulating layer on the sixth surface and is spaced apart from the first and second surfaces of the main body; and
an external electrode that covers the conductive layer and a portion of the insulating layer and connects to the coil.

11. The coil electronic component of claim 10, further comprising:
another insulating layer disposed on the fifth surface of the main body.

12. The coil electronic component of claim 10, further comprising:
the another insulating and the insulating layer are spaced apart from each other.

13. The coil electronic component of claim 10, wherein
among the first to sixth surfaces of the main body, the conductive layer is disposed only on the sixth surface.

14. The coil electronic component of claim 10, wherein
the conductive layer is in contact with the sixth surface of the main body.

15. The coil electronic component of claim 10, wherein
the coil includes a lead-out portion extending to one of the first and second surfaces, and
the external electrode extends from the sixth surface to the one of the first and second surfaces to be in contact with the lead-out portion.

16. The coil electronic component of claim 15, wherein
the external electrode is in contact with the lead-out portion, the conductive layer, and the insulating layer.

17. The coil electronic component of claim 10, wherein
the external electrode includes:
a first metal layer that covers the first conductive layer;
a second metal layer that covers the first metal layer; and
a third metal layer that covers the second metal layer.

18. The coil electronic component of claim 17, wherein
the first metal layer includes copper (Cu),
the second metal layer includes nickel (Ni), and
the third metal layer includes tin (Sn).

19. The coil electronic component of claim 10, wherein
the conductive layer includes a portion disposed between the insulating layer and the external electrode to be in contact with the insulating layer and the external electrode.

20. The coil electronic component of claim 10, wherein
the conductive layer includes at least one of silver (Ag) powder, silver (Ag)-coated powder, copper (Cu) powder, or silver (Ag) alloy powder.
